(19) United States
(12) Patent Application Publication
(10) Pub. No.: US 2025/0298388 A1
(43) Pub. Date: Sep. 25, 2025

(54) MACHINE AND METHOD FOR OPERATOR-GUIDED COMMISSIONING OF THE MACHINE

(71) Applicant: Krones AG, Neutraubling (DE)

(72) Inventors: Jesse SCHMUCK, Flensburg (DE); Johannes LEDDERER, Harrislee (DE)

(21) Appl. No.: 19/084,285

(22) Filed: Mar. 19, 2025

(30) Foreign Application Priority Data
Mar. 20, 2024 (DE) 102024107937.1

(51) Int. Cl. G05B 19/05

(52) U.S. Cl. CPC G05B 19/054; G05B 2219/13144

(57) ABSTRACT

The disclosure relates to a machine and a method for operator-guided commissioning of the machine, in particular a machine in a machine line for filling and packaging food and/or beverages. The disclosure reads out a commissioning status for blocks in a programmable logic controller of the machine. The commissioning status of a block is stored in the PLC and indicates whether or not the block has already been put into operation. The commissioning status for the block is transferred to a server and, if the commissioning status indicates that the block has not yet been put into operation, one or more action instructions are received from the server. The received action instruction can be output to a user. The commissioning status for the block is changed in the PLC based on a user action.

### CROSS REFERENCE TO RELATED APPLICATION

The present application claims priority to German Patent Application No. 10 2024 107 937.1 filed on Mar. 20, 2024. The entire contents of the above-listed application are hereby incorporated by reference for all purposes.

### TECHNICAL FIELD

The disclosure relates to a machine and a method for operator-guided commissioning of the machine, in particular of a machine in a machine line for filling and packaging food and/or beverages.

### BACKGROUND

Today's filling and packaging plants in the liquid food industry are highly optimized and process up to 120,000 units per hour. A typical filling and packaging plant typically comprises a variety of different machines and modules that are connected to one another via conveyor belts.

### SUMMARY

These machines are often dismantled for shipping from a manufacturer to the customer and thus lose the character of being tested in the factory. Large machines or machine systems, such as tunnel pasteurizers, are so large that they cannot even be installed and tested in the factory. The machines are first mechanically installed at the customer's site, where they are then wired and put into operation. Many errors can occur in this highly complex process so that the installation and wiring must be extensively tested before commissioning.

This I/O test must be carried out carefully by a commissioning engineer. However, it is often the case that these tests are carried out only in limited measure due to time constraints and other problems.

For example, the commissioning of complex machines has often been carried out based on the operator's experience. This means that the operator has decided which steps and checks were necessary based on his previous experience with similar machines. There is a risk of deviations from the specific manufacturer recommendations. Such deviations may result in certain safety-related or performance-optimizing steps being overlooked, potentially affecting the performance of the machine or even causing damage or accidents.

A further disadvantage of the previous approach is the lack of systematic logging of the commissioning process. Logging is not only important for quality assurance and traceability reasons but can also play a crucial role in error diagnosis. Without a detailed record of what was done during commissioning, problems that arise later are difficult to attribute or resolve. Documentation often falls by the wayside during previous commissioning, and it is ultimately unclear which work and corrections were carried out. When personnel on the construction sites changes, an information gap arises that usually cannot be closed.

The prior art with regard to the commissioning of complex machines thus has at least two major disadvantages: the risk of deviations from the manufacturer recommendations due to the strong dependence on the individual experience of the operator, and the lack of systematic and automated logging of the commissioning process. There is therefore a need for a solution that closes these gaps and thus increases the safety and efficiency in the commissioning of complex machines.

This object is achieved according to the disclosure by a and a machine as described herein.

One embodiment of the disclosure relates to methods for operator-guided commissioning of a machine, in particular a machine in a machine line for filling and packaging food and/or beverages. This embodiment provides that a commissioning status is read out for blocks in a programmable logic controller (PLC) of the machine. The commissioning status of a block is stored in the PLC and indicates whether or not the block has already been put into operation. The commissioning status for the block is transferred to a server and, if the commissioning status indicates that the block has not yet been put into operation, one or more action instructions are received from the server. The received action instruction can be output to a user. The commissioning status for the block is changed in the PLC based on a user action.

A further embodiment of the disclosure relates to a corresponding machine with operator-guided commissioning. The machine comprises at least one programmable logic controller (PLC), an edge device and an input/output unit. The PLC stores a commissioning status for at least one block of the machine, the commissioning status indicating whether or not the block has already been put into operation. The edge device sends the commissioning status to a server and receives action instructions from the server. The input/output unit outputs action instructions to a user and receives user input and an action instructions from the server.

### BRIEF DESCRIPTION OF THE FIGURES

Exemplary aspects of the disclosure are shown in the drawings. In the figures:

FIG. 1 shows a diagram showing an overview of the essential elements and the basic structure of the disclosure;

FIG. 2: shows a diagram showing an exemplary implementation of the commissioning status in a programmable logic controller (PLC);

FIG. 3: shows an exemplary flow chart for a method for operator-guided commissioning of the machine;

FIG. 4: shows an exemplary plant configuration for PET containers and adhesive packs;

FIG. 5: shows an exemplary plant configuration for PET containers and shrink packers;

FIG. 6: shows an exemplary plant configuration for cans or glass bottles; and

FIG. 7: shows an exemplary plant configuration for cans.

### DETAILED DESCRIPTION

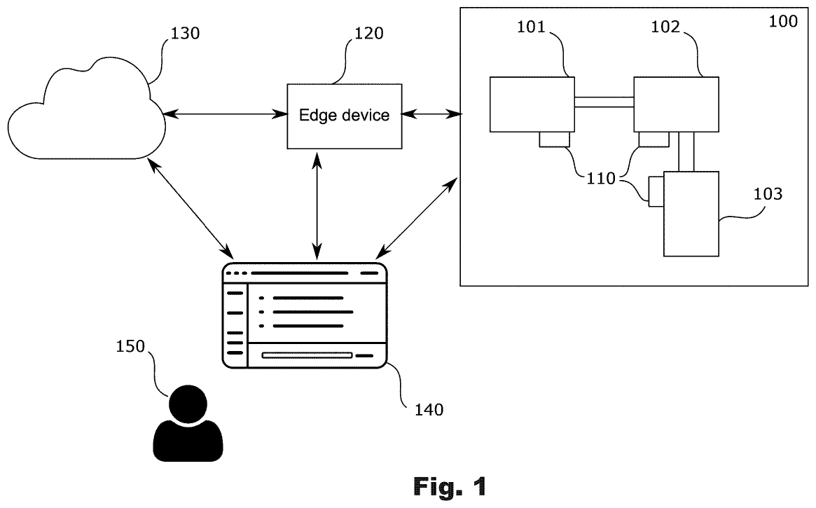

FIG. 1 shows a diagram showing an overview of the essential elements and the basic structure of the disclosure. A machine line 100, for example for filling beverages, comprises one or more machines 101, 102 and 103. The machines 101-103 can be functionally connected to one another, for example via conveyor belts that ensure a transport flow of materials. However, the present disclosure is not limited to a machine line 100 or to a plurality of interconnected machines 101-103. Concepts of the disclosure can also be applied to a single machine.

A machine 101-103 can be controlled using a programmable logic controller (PLC). A PLC is an electronic device specifically developed to control machines, modules and plants in industrial applications. It can serve as an interface between sensors and actuators of a machine or plant and the actual control program that defines the processes and functions. PLCs are generally known. The basic functions of PLCs are discussed below. Essentially, a PLC works by detecting input signals from various sensors (such as temperature sensors, proximity sensors, light barriers, etc.), processing this information according to a pre-programmed algorithm or control logic, and then sending corresponding output signals to actuators (such as motors, valves or relays) in order to perform certain actions.

Programming a PLC is typically done using special software tools and a specified programming language, which is often based on the IEC 61131-3 standard. This standard defines a plurality of programming languages for PLCs, such as function block diagrams. However, the disclosure is not limited to this standard and instead can also be implemented with other PLC programming standards.

A PLC according to exemplary aspects of the disclosure can define inputs, outputs and blocks. Examples of inputs could in particular be inputs for sensors, switches and/or buttons. They can measure physical quantities such as temperature, pressure, position or light intensity. Switches and buttons can be operated manually to trigger a specific state or action in the PLC, such as a start-stop switch for a machine.

Examples of outputs can be actuators, alarm systems, or communication signals. These include motors, valves, heating elements or lights. For example, a PLC output can open or close a valve in a pipeline, activate a warning light or buzzer when a certain state is reached, or send signals to other systems or computers in order to communicate information or trigger actions in other parts of a networked system.

Furthermore, the blocks of a PLC can also comprise more complex function blocks, such as logic blocks for PID controllers, a function block used in many industrial applications to control processes through proportional, integrating and differentiating control. These examples provide an overview of the different types of blocks, such as inputs, outputs and other function blocks, that can be used in a PLC controller.

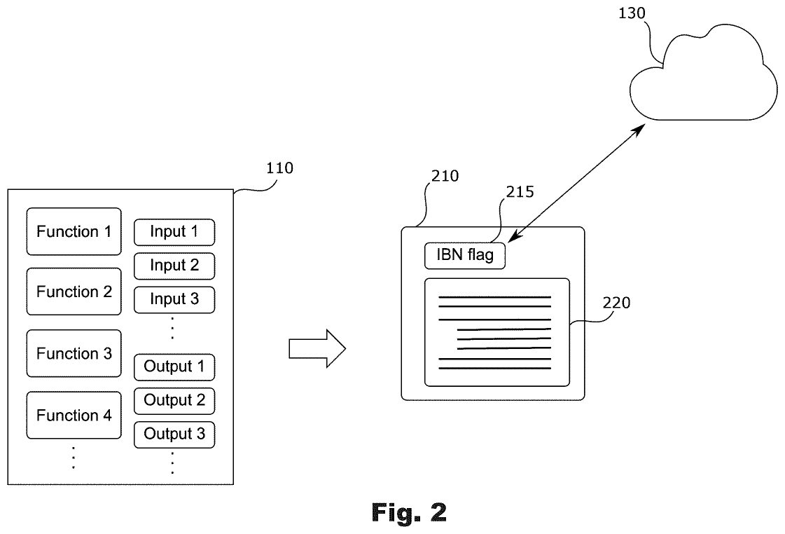

As also seen in FIG. 1, an edge device 120 may be implemented as part of the machine 101-103 or the machine line 100. The edge device 120 can also be coupled to the machines 101-103 as a stand-alone device or can be part of the machine(s) 101-103. Data can be exchanged between the machine line 100 and a server 130 via the edge device 120, as discussed in more detail in particular in connection with FIG. 2.

In addition, according to some embodiments, an input/output unit 140 can be provided for (for example, visually) outputting machine data, information or action instructions to a user 140 or for inputting control commands of the user 150. The input/output unit 140 can be connected to the machine line 100, to individual machines 101-103, to the edge device 120 and/or to the server. The connections may be direct wired or wireless connections or may be indirect connections via a network, such as the Internet or an intranet.

The input/output unit 140 can be a classic HMI (human-machine interface) but can also be a mobile device, such as a smartphone, tablet, computer.

Further details of the PLC 110 according to embodiments of the disclosure are explained with reference to FIG. 2. According to some embodiments of the disclosure, an additional block 215 or additional information in each block of the PLC may be implemented in the PLC 110. This additional information is referred to below as “commissioning status” or IBN flag 215 and indicates whether or not the relevant PLC block has already been put into operation. The IBN flag 215 can, for example, be a defined bit whose state is either “0” or “1”, where, for example, “0” means that the block has not yet been put into operation and “1” means that the block has already been put into operation. The exact definition and implementation of a value of the IBN flag 215 is not limited to this example.

According to embodiments of the disclosure, when booting up or starting a machine, each block (functions, inputs, outputs) implemented in the PLC 110 is “checked” once to ensure that the relevant block is functioning properly. If this is not done before the machine(s) 101-103 is/are put into operation for the first time, it cannot be ensured that the machines 101-103 will function properly.

By default, according to embodiments of the disclosure, the IBN flag 215 for each block in each PLC 110 is set to “0”, i.e., “not yet put into operation,” by the manufacturer of the machine 101-103 before the machine 101-103 is delivered.

A commissioning process can be started when the input/output/function block in a PLC 110 is put into operation for the first time. Then, a specific routine or function within the PLC program can be executed and checks or reads the state of the IBN flag 215. When the machine 101-103 is switched on, the edge device can connect to the server 130 and transmit this IBN flag 215 information of the PLC blocks to the server 130.

The server can use the IBN flag 215 to detect that the blocks have not yet been put into operation, and can then create corresponding tasks (i.e., action or work instruction) for the individual IBN flags 215 in the different blocks. Alternatively, the edge device can also send to the server 130 only those IBN flags 215, or the information contained therein, that indicate that the PLC block has not yet been put into operation.

The action instructions received from the server 130 can, for example, be received via the edge device 120 and displayed to the user via the input/output unit 140.

An example of an action instruction could be, for example, that the user 150 is prompted to go to a specific dirt trap and to clean it, or to go to a defined temperature sensor, take it out and hold it in their hand to successfully detect a temperature change in the PLC 110.

According to some embodiments, functions of the machine can also be verified using digital twins (on the machine 101-103 or the server 130).

This means that every input, output, i.e., every block of the PLC 110 can be put into operation one after the other. The user 150 can also report this commissioning to the system via the input/output unit 140. The user 150 can thus cancel the action instruction, for example by an input that sets the IBN flag 215 to “1”, i.e., to “put into operation.” The server 130 can register the commissioning since the IBN flag 215 is no longer “0” but “1”.

Optionally, the server 130 may also store corresponding parameter values that can be determined by the user action when something is to be parameterized. This allows documentation of the commissioning and the determined values to be carried out at the same time.

The disclosure thus allows increased quality assurance and documentation since the information about the commissioning can be transferred to the server 130. For example, data about the execution, the time of execution and information about the user 150 carrying out the execution can be transferred to the server 130 when the individual PLC 110 is put into operation.

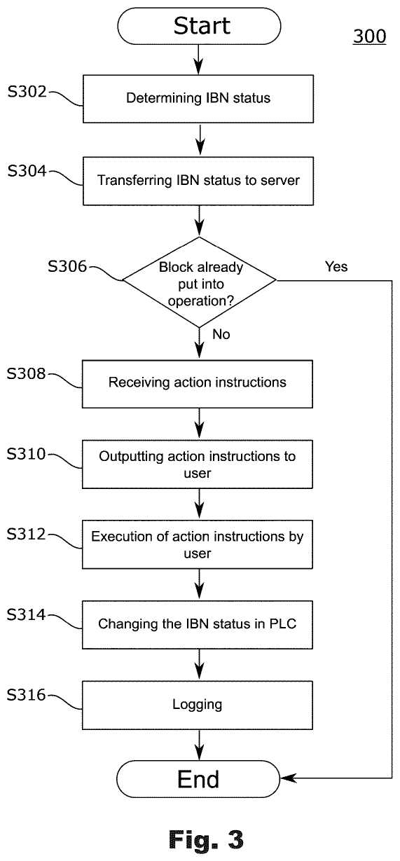

FIG. 3 shows an exemplary flow chart for a method for operator-guided commissioning of the machine 101-103. The method starts at step S302, when a commissioning status (IBN status) is determined. The step may comprise starting a commissioning procedure as soon as the machine is switched on. The commissioning procedure can be used to retrieve the IBN flag 215 for a PLC block. For example, the PLC 110 may automatically transfer the IBN flag 215 for each block of the PLC to the edge device 120 upon initialization, or the edge device 120 may automatically request or read the IBN flags from the corresponding PLCs when the machine is started.

In step S304, the value of the IBN flag 215 is transferred to the server 130. For example, the value of the IBN flag 215 or the commissioning status can be transferred from the edge device 120 to the server. In step S306, the IBN flag 215 is then used to determine whether or not the PLC block has already been put into operation.

It should be noted that steps S304 and S306 can also be combined and that the PLC 110 can itself determine by means of the read IBN flag 215 whether the block has already been put into operation. According to some embodiments, the edge device 120 may also send to the server 130 only those IBN flags 215 for such PLC blocks that indicate that the block has not yet been put into operation.

If the block check in S304 shows that the block has not yet been put into operation, one or more action instructions can be received in step S308. For example, the action instructions are received from the server 130 via the edge device 120. The action instructions can be output to the user or commissioning engineer in step S310. For example, the action instruction can be output to the user 150 via the input/output unit 140.

The user or commissioning engineer can then execute or implement the corresponding instructions in step S312. The execution of the action instructions can be automatically detected by the PLC, for example by sensors that measure a corresponding sensor event when the corresponding action instruction is carried out correctly. In some embodiments, the user may also be prompted by the action instructions to enter appropriate parameters that result from the context. These parameters can be stored by the PLC 110 and/or by the edge device 120 and optionally also be transmitted to the server 130.

When the user executes the action instructions, the commissioning status or the IBN flag 215 of the corresponding PLC block in the PLC 110 is set from “0” to “1”, and the task, i.e., the action instruction, is marked as “executed” and/or canceled on the server 130. The change of the IBN flag 215 in step S314 can occur automatically by the PLC 110 registering the user's action (for example via sensor events) or can be transferred manually by the user 150 to the PLC using the input/output unit 140.

In an optional step S316, the execution of the action instructions by the user 150 can be logged and transferred to the server 130, as described above, after which the method ends.

By carrying out the commissioning according to the disclosure described herein, far-reaching advantages can be generated. The commissioning of the machines 101-103 can be carried out completely, even if functions or inputs/outputs of the PLC are unknown to the commissioning engineer. Commissioning can be documented automatically, and the state of the machine can thus be transparently documented for all subsequent processes.

Furthermore, thanks to the disclosure, multiple commissioning engineers can work on a machine 101-103 in parallel without work being carried out twice or being forgotten. When the construction site personnel changes, the disclosure allows the work status to be clearly and reliably documented and no information is lost. The commissioning status is transparent to everyone (on site and in the factory), allowing for more efficient planning while reducing the frequency of errors.

The commissioning engineers do not need to know all the technical details of the machines 101-103 in order to be able to put the plant into operation. The action instructions can guide the commissioning engineers safely through the activities. The descriptions of the action instructions can be translated into other languages in order to allow further internationalization.

A further advantage of the disclosure is that commissioning can be carried out again later (in the life cycle of the machine 101-103) in order to detect changes. (“Lifecycle Service” (LCS) machine optimizations).

The disclosure makes it possible to achieve a clearly documented state of commissioning and its results (for later troubleshooting in the event of complaints). The qualification level can be lowered for some steps of commissioning, and support from the manufacturer is more efficient since the state data and tasks in the server 130 that are already canceled and open are known. At the same time, the options for remote commissioning are also significantly improved.

Overall, the disclosure can be used to control commissioning, ensure quality and create documentation.

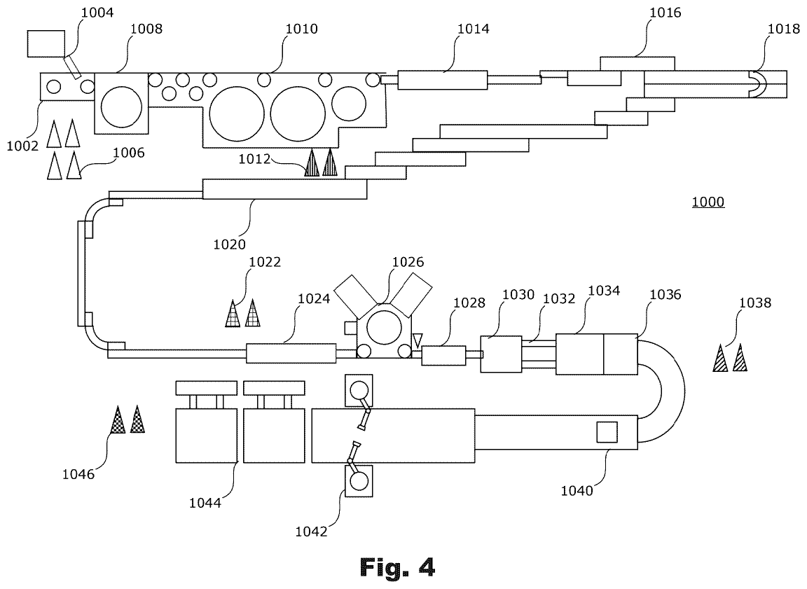

In the following FIGS. 4 to 7, various exemplary plant configurations for different bottle filling plants are described, in which the disclosure or at least parts and aspects of the disclosure can be implemented. The description of FIGS. 4 to 7 is intended only to provide a general overview of machines for which state data can be collected, on the basis of which the LLM can process user requests.

FIG. 4 shows an exemplary plant configuration 1000 for PET bottles or PET containers and adhesive packs. As can be seen in FIG. 4, the plant configuration 1000 comprises the most varied modules, which form a line at the end of which the ready-filled PET containers are dispensed in the form of a pack on pallets. Some of the modules and machines can be optional, and the disclosure is not limited to the exact shape and arrangement of the plant configurations.

The plant configuration 1000 comprises a furnace 1002 for preforms, a preform sorting system with a feeding machine 1004, and a blowing machine 1008. Modules 1002, 1004, and 1008 form in general a stretch blowing machine in which PET containers are manufactured and formed from a starting material. The produced PET containers are forwarded to a filler 1010, in which the bottles are filled. The filler can optionally comprise a rinser. Various particles such as dust, cardboard, or remains of wooden pallets can collect in the preforms during storage or transport. These can be removed with the rinser. At the end of the filler, a closer can be arranged, by means of which the PET containers are closed after filling.

Optionally, the plant configuration 1000 can, after the filler 1010, comprise a rotating apparatus, which is used for hot filling of the PET containers. The filled PET containers are guided to a separator 1020 and further to a drying apparatus 1024, in which the PET containers are dried, via one or more conveyor belts 1016, which can also comprise a buffer 1018 for intermediate loading of filled containers.

After drying, the PET containers are conveyed to a labeling machine 1026. The labeling machine 1026 can be configured for various labeling techniques such as labeling using hot glue, cold glue, self-adhesive labels, or sleeves. After printing or labeling the PET containers, the PET containers are passed through a second drying apparatus 1028, a line distributor 1030, conveyor belts 1032, adhesive packaging production 1034, and a curing section to a handle applicator. In adhesive packaging production 1034, the PET containers are grouped together in certain group sizes and packaged into a pack such as a “six-pack.” In the handle applicator, a carrying handle is attached to the pack, which allows the pack to be carried comfortably. The finished packs are then accordingly arranged by a robot 1042 for layer production and packed on pallets by a palletizer 1044.

In the plant configuration 1000, so-called format trolleys or format racks can be arranged on various modules and machines in order to provide quickly changeable format sets for short changeover times and automatic tool exchange. Examples of format trolleys are the format trolley 1006 for the blowing machine 1008, the format trolley 1012 for the filler 1010, the format trolley 1022 for the labeling machine 1026, the format trolley 1038 for the adhesive packaging production 1034, and the format trolley 1046 for the palletizer 1044.

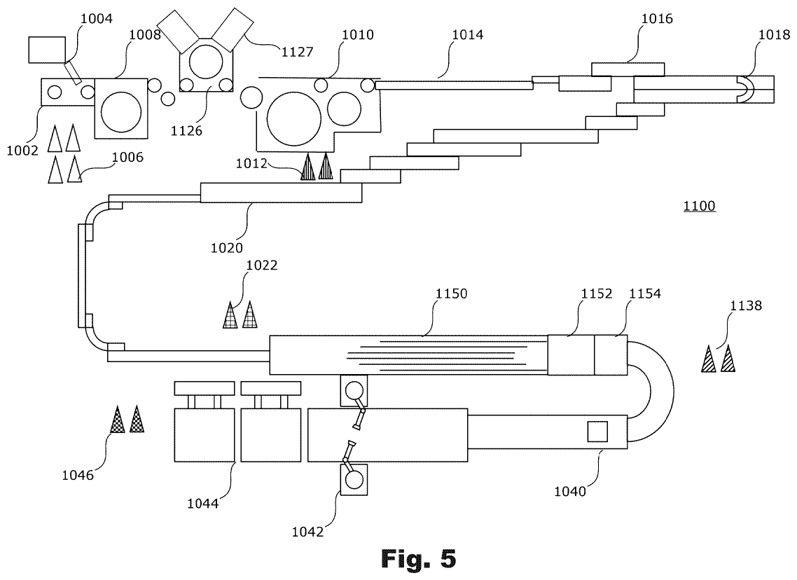

FIG. 5 shows a further exemplary plant configuration 1100 for PET containers and shrink packers. The plant 1100 in FIG. 5 comprises many of the modules and machines from the plant configuration 1000 in FIG. 4, but there are some differences. The description of the modules that are already described in connection with FIG. 4 is therefore omitted for FIG. 5.

A key difference between the two exemplary plant configurations 1000 and 1100 is that the labeling machine 1126 with the labeling modules 1127 can already be installed after the blowing machine 1008 and before the filler 1008. For this purpose, the plant configuration 1100 can comprise six transport lanes 1150 into which the PET containers can be pushed. After the PET containers have been correspondingly pushed into one of the six lanes 1150, they are conveyed into the film wrapping module 1152 and then into the shrink tunnel 1154.

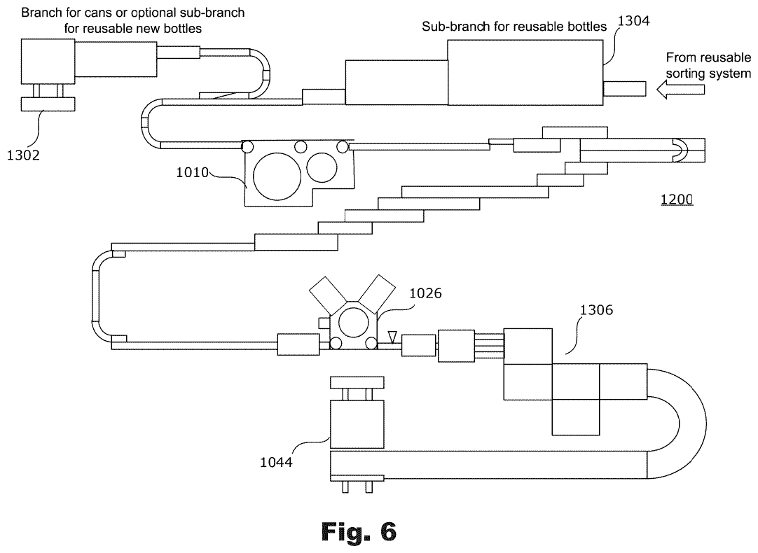

FIG. 6 shows an exemplary plant configuration 1200 for cans or glass bottles. The exemplary plant configuration 1200 of FIG. 6 again has some similarities to the plant configurations 1000 and 1100 of FIGS. 4 and 5, and the description of the plant configuration is therefore limited to the differences between the plant configurations.

As shown in FIG. 6, the exemplary plant configuration can comprise two separate feeds. A first feed, on the left in FIG. 6, shows a branch for cans or, optionally, a sub-branch for reusable new bottles. The containers, i.e., cans or new bottles, are fed from a depalletizer 1302 into the machine, where they are guided via conveyor belts to the filler 1010. A second feed, on the right in FIG. 6, shows a sub-branch for reusable bottles, which are introduced into the plant from a reusable sorting plant (not shown).

In the case where the reusable bottles that have already been used are introduced into the plant 1200 via the sub-branch for reusable bottles, the reusable bottles first pass through the cleaning machine or washing machine 1304. Another possible difference of the exemplary plant configuration 1200 is the transfer packer 1306 after the labeling machine 1026. The transfer packer can sort the bottles or cans into a carton clip application or into boxes, or both.

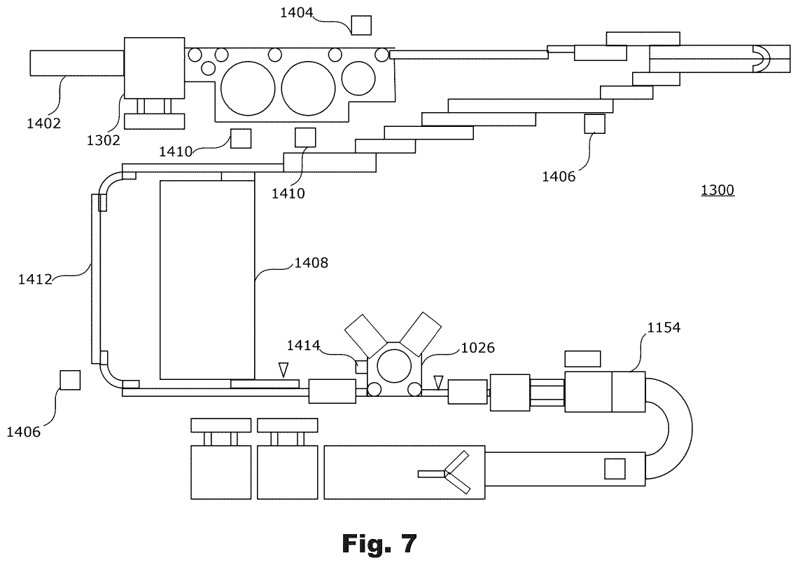

FIG. 7 shows an exemplary plant configuration 1300 for cans, in which the elements already described in the other plant configurations are not described. The cans in the plant configuration 1300 are introduced from a magazine 1402 with cans into the depalletizer 1302. After the cans have passed through the filler and are filled, they are closed by means of a closure magazine 1404 and are then transported further along the plant 1400 via the conveyor belts as described above.

The optional pasteurizer 1408 can be circumvented via the bypass 1412 if it is not required. In the pasteurizer 1408, the freshly filled products can be pasteurized for preservation.

In contrast to the plant configurations 1000, 1100, and 1200, the exemplary plant configuration 1300 shows various tanks for corresponding consumables, such as the tanks 1410 with rinsing liquid and/or the filling product, and the tanks 1406 with belt lubricant. These tanks can also be contained in the above-described exemplary plant configurations. For example, the chemical products 106 that are fed from the mixer 110 to the machines can be stored in the tanks 1406 and 1410.

1. A method for operator-guided commissioning of a machine, wherein the method comprises:
reading out a commissioning status for at least one block in a programmable logic controller of the machine, wherein the commissioning status of a block is stored in the PLC and indicates whether or not the block has already been put into operation;
transferring the read commissioning status for the at least one block to a server;
receiving an action instruction from the server if the commissioning status for the at least one block indicates that the block has not yet been put into operation;
outputting the received action instruction to a user; and
changing the commissioning status for the at least one block in the PLC based on an execution of the action instruction by the user.

2. The method according to claim 1, wherein the block in the PLC is a control routine for an input, an output and/or a function block.

3. The method according to claim 1, wherein execution of the action instruction by the user is automatically detected by the PLC by means of sensors and the PLC changes the commissioning status based on sensor data.

4. The method according to claim 1, wherein the PLC changes the commissioning status based on a manual user input.

5. The method according to claim 1, also comprising:
transferring data about the execution of the action instruction by the user to the server, wherein the data comprise information indicating that the action instructions were executed, when the action instructions were executed, by whom the action instructions were executed, and/or which parameter values were determined and/or set by the action instructions.

6. The method according to claim 1, wherein the action instructions for commissioning a block comprise one or more tests to be carried out to determine whether relevant functional characteristics are fulfilled and/or whether correct level sensors in the machine measure a certain level.

7. A machine with operator-guided commissioning, wherein the machine comprises:
at least one programmable logic controller, wherein the PLC is configured to store a commissioning status for at least one block of the machine, wherein the commissioning status of a block indicates whether or not the block has already been put into operation;
an edge device configured to send the at least one commissioning status to a server and to receive action instructions from the server; and
an input/output unit configured to output action instructions to a user and to receive user input,
wherein at least one action instruction is received from the server via the edge device and displayed via the input/output unit if the commissioning status for the at least one block indicates that the block has not yet been put into operation, and wherein the commissioning status for the at least one block is changed in the PLC based on an execution of the action instruction by the user.

8. The machine according to claim 7, wherein the input/output unit is an HMI and/or a mobile device connectable to the machine.

9. The machine according to claim 7, wherein the execution of the action instruction by the user is automatically detected by the PLC by means of sensors and the PLC changes the commissioning status based on sensor data.

10. The machine according to claim 7, wherein the PLC changes the commissioning status based on a manual user input.

11. The method according to claim 1, wherein the machine line is for filling and packaging food and/or beverages.

12. The machine according to claim 1, wherein the machine line is for filling and packaging food and/or beverages.

13. The machine according to claim 7, wherein the input/output unit is an HMI.

14. The machine according to claim 7, wherein the input/output unit is a mobile device connectable to the machine.
